(19) United States
(12) Patent Application Publication
(10) Pub. No.: US 2019/0385122 A1
(43) Pub. Date: Dec. 19, 2019

(54) SYSTEM AND METHOD FOR THE SAME

(71) Applicant: CANON KABUSHIKI KAISHA, Tokyo (JP)

(72) Inventor: Yuichi Kurahashi, Kawasaki-shi (JP)

(21) Appl. No.: 16/420,395

(22) Filed: May 23, 2019

(30) Foreign Application Priority Data
Jun. 13, 2018 (JP) 2018-112959

(51) Int. Cl. G06Q 10/10

(52) U.S. Cl. CPC G06Q 10/10

(57) ABSTRACT

A server management server acquires the activation status of a customer tenant and controls, if it is determined that the customer tenant has been activated, transmission of a notification including a URL for accessing an agreement screen which is provided by a service providing server and is used to agree to collection of information on a customer by a system and use of the information on the customer for a service, and controls, if it is determined that the customer tenant has not been activated, transmission of a notification including a URL for accessing an agreement screen which is provided by an authentication server and is used to agree to start of use of the customer tenant.

### BACKGROUND OF THE INVENTION

### Field of the Invention

The present invention relates to a system and method related to providing a service via a network.

### Description of the Related Art

In recent years, there have come to be many businesses that provide cloud-type services and other services to customers using servers installed on the Internet. In such a business, a plurality of different services are provided and a customer selects a service that he/she wants to use from the services, and a contract mode in which only a contract relating to necessary services is signed is adopted.

In such a service, when providing a service to a customer company, a service provider creates a new tenant and assigns it to the customer company. An account of an initial user for allowing the customer company to manage the new created tenant is created and registered in the tenant. The service provider sets a service contracted by the customer company from among a plurality of services that are provided and notifies the customer company of information indicating that the tenant has been created, information of the tenant, and information used to activate the tenant.

The customer company can log into the service with the created account of the initial user, activate the tenant, add a user to the assigned tenant, and perform necessary settings to start using the service. The customer company may sometimes be required to agree to the terms of use, the handling of personal information, and the like that a service providing company defines for use of the service, subsequently after performing such a task of activating the tenant.

Cases such as a case in which such a task of agreeing to the terms of use, the handling of personal information, and the like needs to be performed individually for each service and a case in which all services are made available when a single task of agreeing to the terms of use, the handling of personal information, and the like common to the services is performed can be conceived. In a system disclosed in Japanese Patent Laid-Open No. 2014-232359, if it is required to agree to the terms of use for each of a plurality of services, it is possible to access each service and start using the service only after agreeing to the terms of use for all of the plurality of services.

In a system in which a plurality of different services are provided, after starting to use some of the plurality of services, a customer company may sign a contract to additionally use another service. For example, cases such as a case in which a customer has previously signed a contract for some services and then starts using services and a case in which a customer signs a contract for other services in addition to already contracted services, for example, when a service providing company sells new services can be conceived. In these cases, the service provider needs to request that the customer company repeat the task of agreeing to the terms of use, the handling of personal information, and the like for the added services.

However, in such a scheme of providing notification that activation of the tenant and the task of agreeing to the terms of use, the handling of personal information, and the like are to be consecutively performed as described above, there is a possibility of causing unnecessary confusion to the customer company. For example, the notification scheme of the related art may cause a misunderstanding that a new tenant has been created although the customer company has already activated the tenant. On the other hand, if the customer company has not activated the tenant, it is necessary to activate the tenant before agreeing to the terms of use, the handling of personal information, and the like.

### SUMMARY OF THE INVENTION

The present invention provides a system for providing services which can appropriately control content of a notification that is provided to a customer when a service is added to a customer tenant afterwards.

A system of an embodiment of the present invention includes a server configured to manage a customer tenant prepared for each customer to manage information on the customer and a server configured to provide a service to the customer using the information on the customer managed in the customer tenant, wherein the server configured to manage the customer tenant includes a memory storing instructions and a processor executing the instructions causing the server configured to manage the customer tenant to acquire an activation status of the customer tenant, determine whether or not the customer tenant has been activated, control, if the customer tenant has been activated, transmission of a notification including access information for accessing an agreement screen, which is provided by the server configured to provide the service and is used to agree to collection of information on the customer by the system and use of the information on the customer for the service, as first transmission, and control, if the customer tenant has not been activated, transmission of a notification including access information for accessing an agreement screen, which is provided by the server configured to manage the customer tenant and is used to agree to start of use of the customer tenant, as second transmission.

Further features of the present invention will become apparent from the following description of exemplary embodiments with reference to the attached drawings.

### BRIEF DESCRIPTION OF THE DRAWINGS

FIG. 1 is a diagram showing an example of the configuration of a system according to an embodiment of the present invention.

FIG. 2 is a diagram showing a hardware configuration of an authentication server.

FIG. 3 is a diagram showing software configurations of server computers.

FIGS. 4A and 4B show examples of a notification email and a screen that is accessible through the notification email.

FIGS. 5A and 5B show examples of a notification email and a screen that is accessible through the notification email.

FIG. 6 is a diagram showing processing for notifying that a service has been registered in a tenant of a customer.

FIGS. 7A and 7B show examples of a checking screen for checking the content of notification.

### DESCRIPTION OF THE EMBODIMENTS

Hereinafter, embodiments of the present invention will be described with reference to the drawings or the like.

### First Embodiment

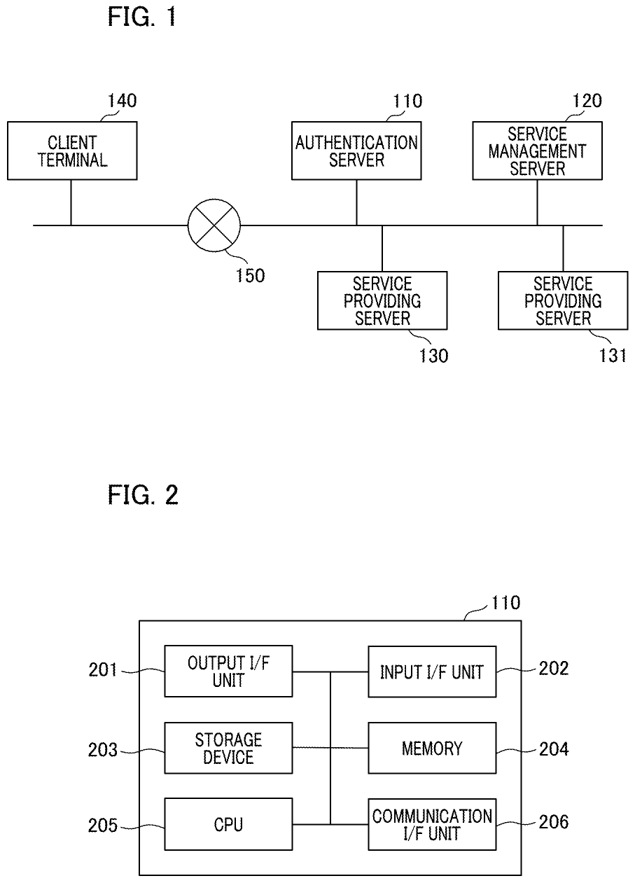

FIG. 1 is a diagram showing an example of the configuration of a system according to an embodiment of the present invention.

In the system of the present embodiment, an authentication server 110, a service management server 120, service providing servers 130 and 131, and client terminals 140 are configured such that they can communicate with each other via a network 150.

The authentication server 110 is an authentication server that authenticates users of customers who use application services (hereinafter, services) on a cloud. When a provider of an application service, i.e., a service provider, provides a service to a customer, the authentication server 110 creates a new customer tenant (hereinafter referred to as a “tenant”), which is to be prepared for each customer, to manage information on the customer. Then, the service provider assigns the created tenant to the customer. Also, the service provider creates an account of an initial user in the tenant assigned to the customer and notifies the customer that the tenant has been created.

The service management server 120 manages statuses or the like of service provision to customers for a plurality of services that are provided by the service providing servers 130 and 131 or the like. Further, the service management server 120 registers a service to be provided to a customer in a tenant of the customer, for example, by granting a license for the service to the tenant. The service management server 120 requests that a user of the customer agree to the terms of use, the handling of personal information, and the like, which is necessary when starting to use the service.

Agreeing that is necessary when starting to use the service includes, for example, agreeing to collection of information on the customer by the system or agreeing to use of the collected information for each service. Agreement of the user of the customer allows the service providing servers 130 and 131 to provide the service. A service provider which creates a tenant and a service provider which registers a service in the created tenant, that is, a service provider which grants a license, may be the same or different.

The service providing servers 130 and 131 are servers that provide various functions (services) to the client terminals 140 via the network 150 such as the Internet. The services include a service that collects (uploads) data of a customer's device in the cloud and provides the data when accessed. Examples include a backup service that stores collected data as a backup and a device monitoring service that analyzes the collected data to monitor the operation status of the device via the Internet.

Each of the client terminals 140 is an information processing device which is operated by a user of the customer and has a web browser installed. The configuration of the system shown in FIG. 1 is an example and the present invention is not limited thereto. For example, each of the servers constituting the system is not necessarily realized by one physical server and may be constituted by one or more virtual machines (VMs). The functions of the servers may also be integrated into one physical server.

FIG. 2 is a diagram showing a hardware configuration of the authentication server 110 in the present embodiment. The hardware configurations of the service management server 120, the service providing servers 130 and 131, and the client terminal 140 are also the same. It is to be noted that the hardware configuration shown in FIG. 2 corresponds to that of the hardware block diagram of a general information processing device and the hardware configuration of the general information processing device can be applied to server computers and client terminals of the present embodiment.

In FIG. 2, an output I/F unit 201 is connected to an output device such as a display. An input I/F unit 202 is connected to an input device such as a keyboard. A storage device 203 stores an operating system (OS), an authentication program of the authentication server 110, account information of users of customers who use services, the terms of use common to the services, and the like.

A CPU 205 loads the authentication program from the storage device 203 into a memory 204 and executes the authentication program. A communication I/F unit 206 is a network interface connected to the network 150 to control communication with other server computers and client terminals 140 that constitute the system.

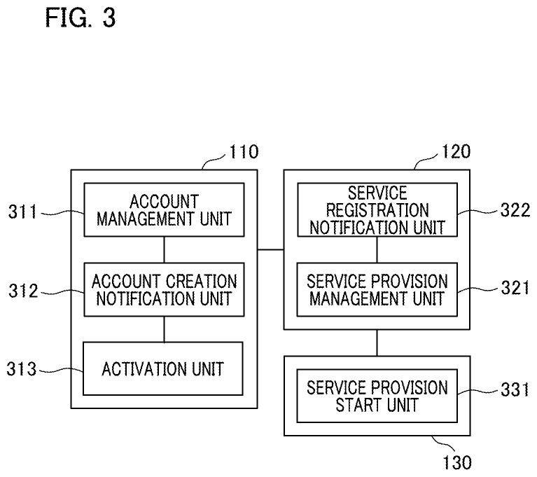

FIG. 3 is a diagram showing software configurations of server computers constituting the system according to the present embodiment.

The software configurations shown in FIG. 3 are particularly software configurations of parts relating to the present invention.

The authentication server 110 includes an account management unit 311, an account creation notification unit 312, and an activation unit 313. The account management unit 311 manages customer information including tenants assigned to customers to which services are provided and user accounts for users of the customers to log into. Table A shows an example of a tenant management table held by the account management unit 311.

TABLE A

| | | | | Administrator Email |
|---|---|---|---|---|
| Tenant ID | Customer Name | Activation Status | Administrator ID | Address |
| 10001 | Company X | Not activated | user10001 | administrator@x.com |
| 10002 | Company Y | Activated | user10002 | administrator@y.com |
| 10003 | Company Z | Activated | user10003 | administrator@z.com |

Table A includes a tenant ID, a customer name, an activation status, an administrator ID, and an administrator email address. The tenant ID is an identifier for uniquely identifying a tenant assigned to a customer. The customer name is the name of the customer. The activation status is status information of the tenant indicating whether or not an initial user of the tenant has logged in and started using the tenant, that is, whether or not the tenant has been activated.

When a user of the customer logs in with an account of an initial user created in the tenant, the created tenant is handed over to the customer to make the tenant available to the customer. Making the tenant available to the customer in this way is called “activation.” If the value of the activation status is “not activated,” this indicates that the initial user of the tenant has not logged in.

The value of the activation status “not activated” indicates that the initial user has successfully logged in and started using the tenant. The administrator ID indicates a user ID of a representative of the tenant of the customer and indicates a user ID of an initial user if the value of the activation status is “not activated.”

The administrator email address indicates an email address of the representative of the tenant of the customer. If the activation status value is “not activated,” the administrator email address is an email address of an operation administrator of the customer specified by the service provider, for which a notification destination email address for notifying the customer of account information of the initial user has been set. In addition, if the value of the activation status is “activated,” the setting of the administrator email address can be changed by the customer's initial user after login and indicates the email address of the current operation administrator of the customer.

The account creation notification unit 312 sends a notification that the tenant has been created to the customer. The notification includes information of the tenant assigned to the customer and information for activating the tenant, and is sent to the email address of the representative of the tenant of the customer. The activation unit 313 causes an activation screen for first login to be displayed when the representative of the tenant of the customer who has received the notification has accessed a predetermined ULR and activates the tenant in response to the initial user successfully logging in.

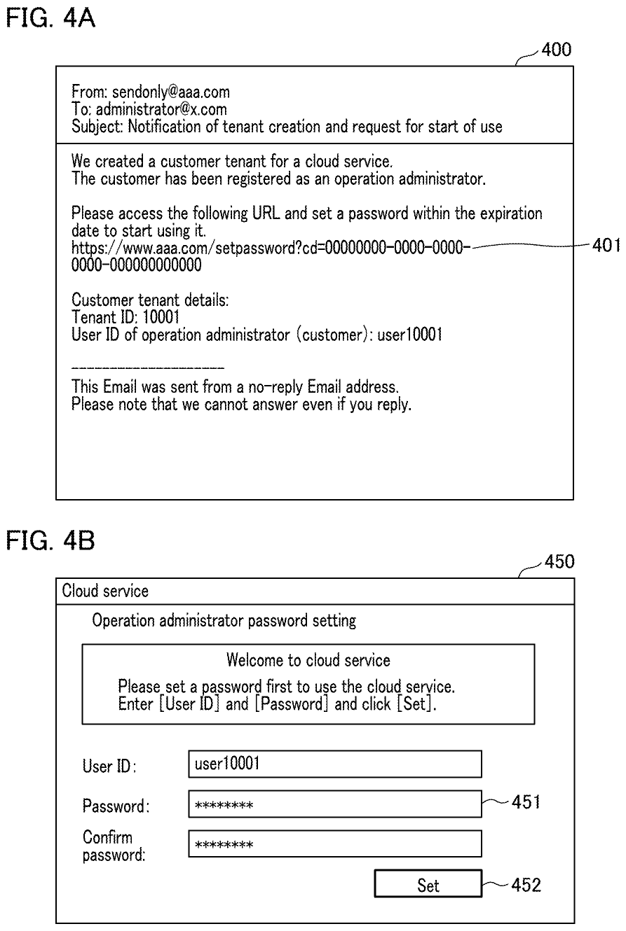

FIG. 4A is a diagram showing an example of an email of which the account creation notification unit 312 of the authentication server 110 notifies the representative of the tenant of the customer.

A URL (access information) 401 for allowing the initial user of the tenant to agree to the start of use of the tenant and to activate the tenant is written into the tenant creation notification email 400.

When the representative of the tenant of the customer who has received the notification email has accessed the URL 401 through the web browser, an activation screen for first login such as that for initial setting of a password is displayed. A URL with an expiration date may be used as the URL 401. If a URL with an expiration date is used, the representative of the tenant of the customer who has received the notification email needs to access the URL within the expiration date.

FIG. 4B is a diagram showing an example of a screen displayed at the time of first login.

An activation screen 450 is an agreement screen that the activation unit 313 displays when the URL 401 written into the tenant creation notification email 400 which the account creation notification unit 312 has provided as a notification is accessed. When a password 451 for using the service is input and a setting button 452 is pressed on the activation screen 450, the activation unit 313 activates the tenant to make the tenant available.

Returning to the explanation of FIG. 3, the service management server 120 includes a service provision management unit 321 and a service registration notification unit 322. The service provision management unit 321 manages services registered in the tenant and provision statuses of the services on the basis of a contract with the customer. Table B shows an example of a service provision management table held by the service provision management unit 321.

TABLE B

| Tenant ID | Service A | Service B |
|---|---|---|
| 10001 | Not started | Not started |
| 10002 | Not started | Being provided |
| 10003 | Unregistered | Being provided |

Table B includes columns indicating tenant IDs and service provision statuses corresponding to services that can be provided to customers. In the example shown in Table B, it is assumed that the system provides a service A and a service B. A tenant ID is an identifier for uniquely identifying a tenant. Service A and Service B indicate the respective statuses of provision of services provided by the service providing servers 130 and 131 to the tenants.

If the value of the provision status is “not started,” this indicates a state in which the service provider has registered the service in a tenant of a customer, for example, by granting a license for the service to the tenant of the customer. If the value of the provision status is “being provided,” this indicates a state in which the service has started being used since the representative of the tenant of the customer has agreed to the terms of use, the handling of personal information, and the like of the service after the service was registered in the tenant. If the value of the provision status is “unregistered,” this indicates that the service has not been registered for the tenant of the customer.

The service registration notification unit 322 provides, to the email address of the representative of the tenant of the customer, a notification that the service provider has registered the service in the tenant of the customer, for example, by granting a license for the service to the tenant of the customer.

The service providing server 130 includes a service provision start unit 331. The service provision start unit 331 causes a service start screen including the terms of use of the registered service to be displayed when a predetermined URL is accessed by the representative of the tenant of the customer who has received the notification from the service registration notification unit 322. Then, the service provision start unit 331 starts providing the service to the customer in response to the user agreeing to the terms of use.

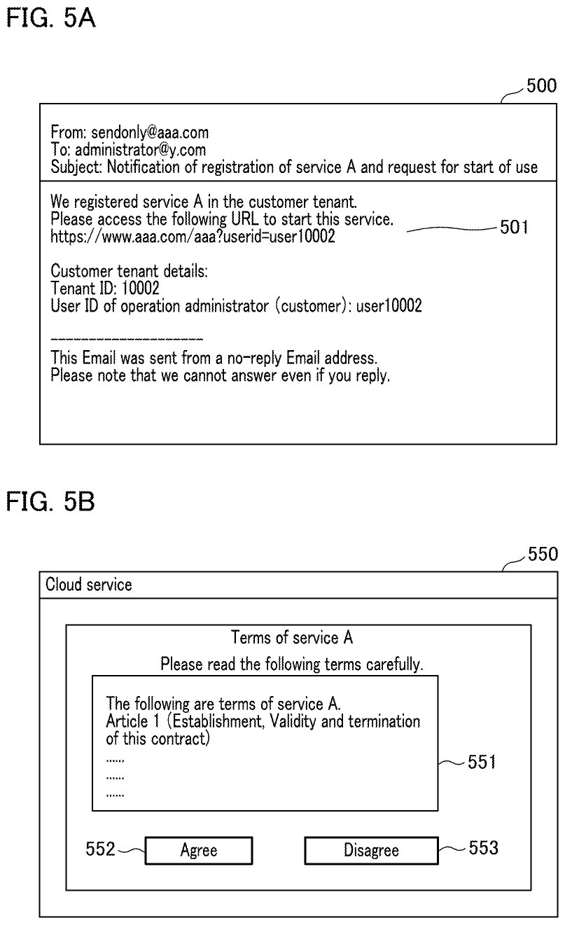

FIG. 5A is an example of a notification email that the service registration notification unit 322 of the service management server 120 provides to the representative of the tenant of the customer as a notification.

A URL (access information) 501 for allowing the representative of the tenant of the customer to agree to the terms of use, the handling of the personal information, and the like of the service registered in the tenant is written into the service registration notification email 500. When the representative of the tenant of the customer who received the notification email has accessed the URL 501 through the web browser, a service start screen for the registered service is displayed.

If the authentication server 110 performs authentication such that login of the initial user is unsuccessful, the authentication server 110 causes an activation screen to be displayed. Then, the service start screen for the registered service is displayed after the login succeeds, i.e., after the tenant is activated. If an additional service is registered in the tenant after the tenant and the service start being used, the additional service may sometimes have no set individual terms of use and thus it may be unnecessary for the customer to agree to the additional service or access it via a web browser.

In such a case, the service management server 120 may hold information as to whether or not each service has set individual terms of use and allow a URL 501 to be written into the service registration notification email 500 only in the following cases. That is, a URL 501 may be written into the service registration notification email 500 only when a service that is additionally registered afterwards has set individual terms of use.

FIG. 5B is a diagram showing an example of a screen displayed at the time of first login into a service.

A service start screen 550 is an agreement screen that the service provision start unit 331 displays when the URL 501 written into the service registration notification email 500 that the service registration notification unit 322 has provided as a notification is accessed. Terms of use 551 of the registered service, an agree button 552 indicating that the user agrees to the terms of use 551, and a refuse button 553 indicating that the user does not agree are displayed on the service start screen.

When the agree button 552 is pressed, the service provision start unit 331 requests that the service provision management unit 321 update the provision status of the corresponding service to “being provided.” Also, the service provision start unit 331 starts providing the service to the customer. That is, the service provision start unit 331 permits the user of the tenant of the customer to access the corresponding service. On the other hand, when the refuse button 553 is pressed, the service provision start unit 331 rejects access to the corresponding service by the user of the tenant of the customer.

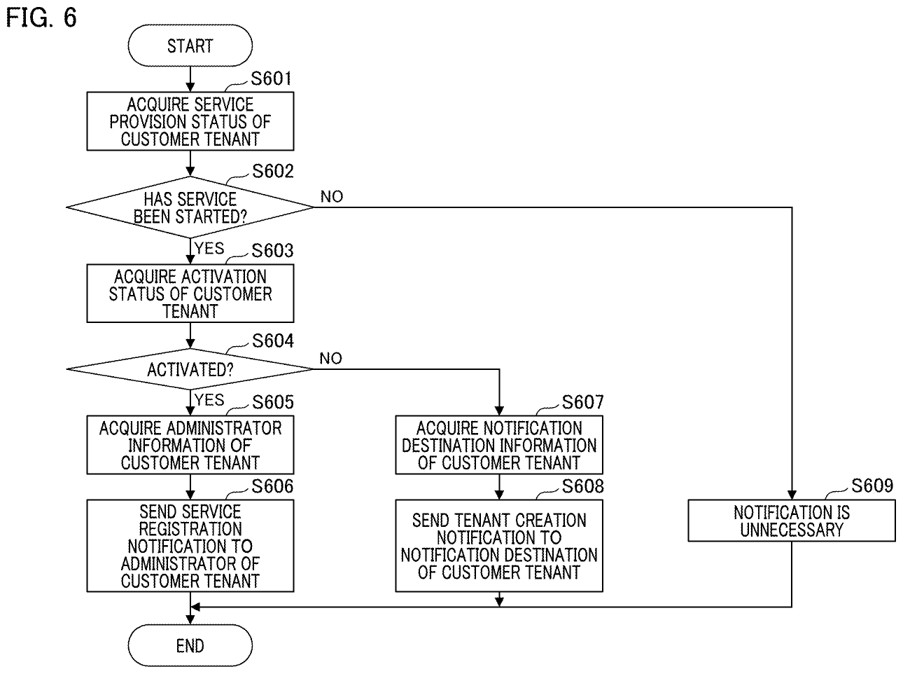

FIG. 6 is a flowchart showing processing when the service provider notifies the customer that a service has been registered for the tenant of the customer through the service registration notification unit 322.

If the service provider newly provides a service to the customer and there is a tenant assigned to the customer, the service provider registers the service in the tenant, for example, by granting a license to the service.

On the other hand, if the service provider newly provides a service to the customer and there is no tenant assigned to the customer, the service provider newly creates a tenant and assigns the tenant to the customer and then registers the service in the tenant. In addition, if there are necessary settings or the like for a service before starting providing the service to the customer, the service provider performs such settings or the like and then notifies the representative of the tenant of the customer that the service has been registered.

The process shown in FIG. 6 is realized by the service management server 120 executing a service management program upon receiving an operation performed by the service provider. The service management program is stored in the storage device 203 of the service management server 120 and the CPU 205 reads the service management program into the memory 204 to execute it.

First, in step S601, the service registration notification unit 322 acquires, from the service provision management unit 321, the provision status of a service registered in a tenant for which it is to be notified that the service has been registered. Specifically, the service registration notification unit 322 acquires the provision status of the service from the service provision management table (Table B) held by the service provision management unit 321.

In step S602, the service registration notification unit 322 determines whether or not the acquired provision status of the service is “not started,” and the process proceeds to step S603 if the acquired provision status is “not started” and proceeds to step S609 if the acquired provision status is not “not started.” In step S603, the service registration notification unit 322 acquires, from the account management unit 311, the activation status of the tenant for which it is to be notified that the service has been registered.

Specifically, the service registration notification unit 322 acquires the activation status of the tenant from the tenant management table (Table A) held by the account management unit 311. In step S604, the service registration notification unit 322 determines whether or not the acquired activation status of the tenant is “activated.” The process proceeds to step S605 if it is determined that the activation status is “activated,” and proceeds to step S607 if it is determined that the activation status is not “activated.”

In step S605, the service registration notification unit 322 acquires, from the account management unit 311, an administrator email address set for the tenant for which it is to be notified that the service has been registered. Specifically, the service registration notification unit 322 acquires the administrator email address of the tenant from the tenant management table (Table A) held by the account management unit 311.

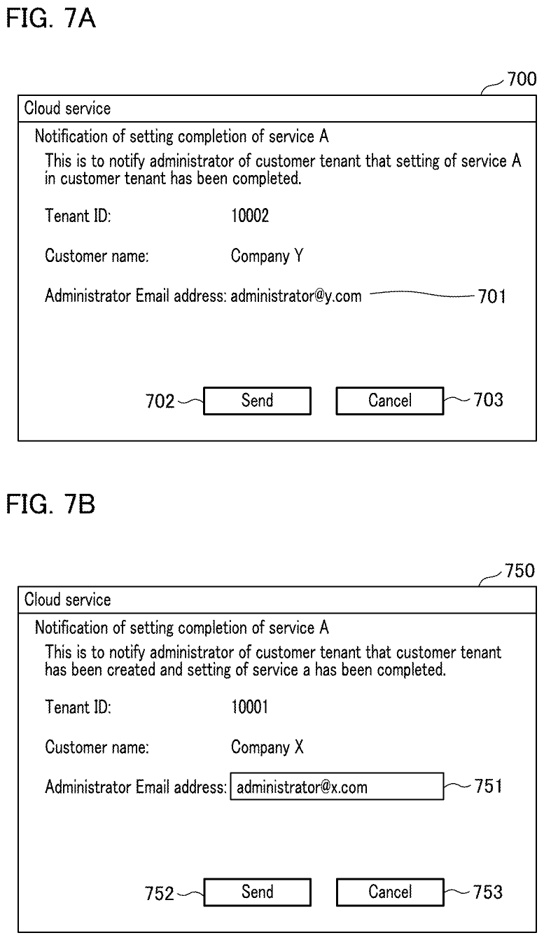

Then, in step S606, the service registration notification unit 322 sends a service registration notification email 500 to the acquired administrator email address as a notification that the service has been registered. In this way, a notification that the service has been registered can be sent to the representative of the tenant of the customer and thus the representative can be prompted to perform an operation such as agreeing to the terms that is necessary when starting to use the service. It is to be noted that the service registration notification unit 322 may present a checking screen to the service provider before sending the notification that the service has been registered. Details of the checking screen will be described later using FIG. 7A.

Step S607 is executed if it is determined in step S604 that the activation status of the tenant is not “activated,” that is, that the tenant is “not activated”. If the tenant is “not activated,” it is necessary to perform an operation for making the tenant available, that is, an operation of activating the tenant, before performing an operation such as agreeing to the terms that is necessary when starting to use the service.

Specifically, the initial user of the tenant needs to log in and perform a predetermined operation. To this end, in steps S607 to S608, the service registration notification unit 322 notifies the representative of the tenant of the customer of information for activating the tenant via the account creation notification unit 312, and prompts the first login. Specifically, in step S607, the service registration notification unit 322 acquires, from the account management unit 311, the notification destination email address of information for activating the tenant.

Then, in step S608, the service registration notification unit 322 instructs the account creation notification unit 312 to send a tenant creation notification email 400 for activating the tenant to the acquired notification destination email address. In this way, the information for activating the tenant can be sent to the representative of the tenant of the customer and the customer can be prompted to activate the required tenant before starting to use the service.

In addition, when the tenant has been activated, it is possible to continue to prompt an operation such as agreeing to the terms that is necessary when starting to use the service. For example, after the screen of FIG. 4B is displayed when the representative of the tenant of the customer has accessed the URL 401 written into the tenant creation notification email 400, the screen may transition to the screen of FIG. 5B. A checking screen may also be presented to a service provider before providing notification of the information for activating the tenant. Details of the checking screen will be described later using FIG. 7B.

Step S609 is executed if it is determined in step S602 that the provision status of the service is not “not started,” that is, that the service is “being provided”. If the service is “being provided,” it is unnecessary to notify that the service has been registered since the customer has performed an operation such as agreeing to the terms that is necessary when starting to use the service. Therefore, the process shown in FIG. 6 ends.

FIG. 7A is a diagram showing an example of a checking screen displayed before the service provider sends a notification that the service has been registered to the customer.

A checking screen 700 is a screen that the service registration notification unit 322 presents to the service provider in step S606. An administrator email address 701 in the checking screen 700 is the administrator email address acquired in step S605. Thus, information of the tenant of the customer for which it is to be notified that that the service has been registered, the information including the administrator email address 701, is displayed on the checking screen 700.

Upon checking the presented information, the service provider presses a send button 702 to send the notification and presses a cancel button 703 to cancel the notification. Therefore, it is possible to reduce the likelihood of erroneous sending of the notification. If the send button 702 is pressed, the service registration notification unit 322 sends a service registration notification email 500 to the presented administrator email address 701.

Before sending the notification in step S606, the service registration notification unit 322 may also display, for example, a notification history of the tenant of the customer, without being limited to the checking screen as shown in FIG. 7A. At this time, regarding content to be displayed as the notification history, it is possible to display a notification history of the service registration notification email 500 sent so far to the tenant except the notification history of the tenant creation notification email 400 since the tenant of the customer has already been activated.

FIG. 7B is a diagram showing an example of a checking screen displayed before the service provider sends information for activating the tenant to the customer.

A checking screen 750 is a screen that the account creation notification unit 312 presents to the service provider in step S608. An administrator email address 751 in the checking screen 750 is the notification destination email address acquired in step S607.

Thus, information of the tenant of the customer to which the information for activating the tenant is to be transmitted, the information of the tenant including the notification destination email address, is displayed on the checking screen 750. Upon checking the presented information, the service provider presses a send button 752 to send the notification and presses a cancel button 753 to cancel the notification.

The administrator email address 751 is editable. This is because if the activation status of the tenant is “not activated,” first login has not been performed by the customer and thus, at this time, the validity of the notification destination email address acquired in step S607 has not yet been verified. Therefore, as shown in FIG. 7B, the administrator email address 751 is displayed in an editable state such that it can be changed if there is an error in the checking screen 750.

On the other hand, the administrator email address 701 displayed in FIG. 7A cannot be edited on the checking screen 700 presented to the service provider. This is because first login has been performed by the customer and the validity of the notification destination information such as the email address has been verified in the process of activating the tenant. If the send button 752 is pressed, the account creation notification unit 312 sends the tenant creation notification email 400 to the presented or edited administrator email address 751.

Before instructing the notification in step S608, the service registration notification unit 322 may also display, for example, a notification history of the tenant of the customer, without being limited to the checking screen as shown in FIG. 7B. At this time, regarding content to be displayed as the notification history, it is possible to display a notification history of the tenant creation notification email 400 since the tenant of the customer has not been activated.

As described above, according to the present embodiment, the content of notification to be provided to the customer when a service has been registered is changed depending on the usage status of the service by the customer. Thus, for example, even if a service is added after a tenant has started being used, it is possible to appropriately control the content of notification to be provided to the customer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-112959, filed Jun. 13, 2018, which is hereby incorporated by reference wherein in its entirety.

What is claimed is:

1. A system including a server configured to manage a customer tenant prepared for each customer to manage information on the customer and a server configured to provide a service to the customer using the information on the customer managed in the customer tenant, wherein the server configured to manage the customer tenant comprises:
a memory storing instructions; and
a processor executing the instructions causing the server configured to manage the customer tenant to:
acquire an activation status of the customer tenant;
determine whether or not the customer tenant has been activated;
control, if the customer tenant has been activated, transmission of a notification including access information for accessing an agreement screen, which is provided by the server configured to provide the service and is used to agree to collection of information on the customer by the system and use of the information on the customer for the service, as first transmission; and
control, if the customer tenant has not been activated, transmission of a notification including access information for accessing an agreement screen, which is provided by the server configured to manage the customer tenant and is used to agree to start of use of the customer tenant, as second transmission.

2. The system according to claim 1, wherein, in the first transmission, a first checking screen for checking content of the notification including information on the customer tenant and information relating to a notification destination is displayed before the notification is transmitted, and
in the second transmission, a second checking screen for checking content of the notification including information on the customer tenant and information relating to a notification destination is displayed before the notification is transmitted.

3. The system according to claim 2, wherein the information relating to the notification destination that is displayed on the second checking screen for checking the content of the notification in the second transmission is editable on the second checking screen.

4. The system according to claim 2, wherein the information relating to the notification destination that is displayed on the first checking screen for checking the content of the notification in the first transmission is not editable on the first checking screen.

5. The system according to claim 1, wherein the instructions further cause the server configured to manage the customer tenant to register a service in the customer tenant,
if a service has been registered in the customer tenant and it is determined that the customer tenant has been activated, control is performed such that a notification including access information for accessing a screen provided by the server configured to provide the service is transmitted in the first transmission, and
if a service has been registered in the customer tenant and it is determined that the customer tenant has not been activated, control is performed such that a notification including access information for accessing a screen used to agree to start of use of the customer tenant is transmitted in the second transmission.

6. The system according to claim 5, wherein, if a service has been registered in the customer tenant and the service has started being used, respective notifications are not transmitted in the first transmission and the second transmission.

7. The system according to claim 1, wherein, in the second transmission, the server configured to manage the customer tenant is instructed to transmit the notification.

8. A method for a system including a server configured to manage a customer tenant prepared for each customer to manage information on the customer and a server configured to provide a service to the customer using the information on the customer managed in the customer tenant, the method comprising:
acquiring an activation status of the customer tenant;
determining whether or not the customer tenant has been activated;
controlling, if the customer tenant has been activated, transmission of a notification including access information for accessing an agreement screen which is provided by the server configured to provide the service and is used to agree to collection of information on the customer by the system and use of the information on the customer for the service; and
controlling, if the customer tenant has not been activated, transmission of a notification including access information for accessing an agreement screen which is provided by the server configured to manage the customer tenant and is used to agree to start of use of the customer tenant.
